(19) United States
(12) Patent Application Publication
(10) Pub. No.: US 2002/0143738 A1
(43) Pub. Date: Oct. 3, 2002

(54) Portable information terminal and control method

(75) Inventors: Daisuke Miyakoshi, Yokosuka-shi (JP); Kazuhiko Muto, Ohta-ku (JP); Hitoshi Yamakado, Hino-shi (JP); Toru Miyamoto, Hachioji-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/083,376

(22) Filed: Feb. 27, 2002

(30) Foreign Application Priority Data
Mar. 27, 2001 (JP) 2001-091422

(51) Int. Cl. G06F 7/00

(52) U.S. Cl. 707/1

(57) ABSTRACT

When storing a user input data such as voice data or image data into a mobile telephone, data processing unit 17 of the mobile telephone relates the user input data with the base station code stored in location information file 12, and stores them in data file 18. Then when data processing unit 17 receives a base station code, it retrieves a user input data such as voice data or image data stored in relation with the base station code. Then when the user input data is a voice data, data processing unit 17 outputs sound from a speaker. When the user input data is an image data, data processing unit 17 displays it on the LCD screen.

### BACKGROUND OF THE INVENTION

1. Field of the Invention

The present invention relates to a portable information terminal and in particular to a portable information terminal capable of receiving location information.

2. Description of Related Art

Portable information terminals such as mobile telephones are in common use. Since the location of such terminals is not fixed, and communication can be performed from different locations, it is necessary for information on a base station with which a terminal communicates to be made available within a mobile communication system to which the terminal belongs. To accomplish this, a mobile communication system is known wherein a code of a base station with which a mobile communication terminal communicates is stored in the mobile communication system as location information. However, in the conventional system a problem exists that a mobile communication terminal stores only a most recent base station code as location information, and is not able to utilize a location information history of different codes.

In an attempt to overcome this problem of the conventional art, Japanese patent application publication No. H8-65736 proposes a mobile telephone that is able to store multiple location information, and to display them.

However, the mobile telephone proposed in H8-65736 suffers from a limitation in that each time it communicates with a different base station, it automatically records the location information of that base station, regardless of whether a user wishes such information to be recorded.

Also, when the mobile telephone does not move between base stations, no new location information is recorded.

Also, the application H8-65736 does not disclose how location information is utilized other than displaying location information for viewing.

### SUMMARY OF THE INVENTION

The present invention has been made to overcome the problems of the conventional and proposed art outlined above, and provides a portable information terminal, a control method, a storage medium, and a program, use of which enables a user of the terminal to store location information as desired. Further, by using the method and device of the present invention, a user of a portable information terminal is able to effectively utilize any location information which is recorded and stored.

To achieve this objective, the portable information terminal according to the present invention comprise:

a storage unit for correlating and storing location information and data;

a receive unit for receiving location information;

an extract unit for extracting data on the received location information from data stored in the storage unit; and

an information notification unit for notifying a user of the portable information terminal of information derived from the extracted data.

Thus, when the receive unit receives location information of a portable information terminal, the extract unit extracts data for that location information from data stored in the storage unit. The notification unit then notifies the user of the information derived from the extracted data. In this way, information which relates to a specific place can be provided to a user when that user moves to that specific place.

A portable information terminal according to the present invention may also comprise:

a receive unit for receiving location information;

an operation unit for instructing data storage; and

a storage unit for correlating and storing, when instructed by the operation unit, data and location information received by the receive unit.

By this configuration, when a user instructs data storage (for example, storage of image data or voice data), the storage unit correlates and stores the data and the location information received at the time of this instruction. Therefore, when data is stored in one place, location information that corresponds to the place is correlated with the data and stored.

Also, a portable information terminal according to the present invention may comprise:

a location information select prompting unit for prompting a user of the portable information terminal to select a particular location information from among different pre-stored location information;

a data select prompting unit for prompting the user to select a data from among various pre-stored data; and

a storage unit for correlating and storing data and location information selected by the user.

By this configuration, location information and data selected by the user are correlated and stored. As a result, a user can correlate selected data with a variety of location information.

A method according to the present invention of controlling a portable information terminal may comprise the steps of:

correlating and storing location information and data;

receiving location information;

extracting data which correlates with the received location information from the data stored at the storing step; and

notifying a user of the portable information terminal of information derived from the extracted data.

A method according to the present invention of controlling a portable information terminal may comprise the steps of:

receiving location information;

instructing the portable information terminal to store data; and

storing and correlating, when the instruction is made at the instructing step, the data and the location information received at the receiving step.

According to the present invention, a method for controlling a portable information terminal may comprise the steps of:

prompting the user of the portable information terminal to select particular location information from among pre-stored location information;

prompting the user to select particular data from among various pre-stored data; and

correlating and storing data and location information selected by the user.

In the present invention, a program stored in the storage medium may enable a computer to execute a method comprising the following steps of:

correlating and storing location information and data;

receiving location information;

extracting data which correlates with the received location information from data which is stored at the storing step; and

notifying a user of the portable information terminal of information derived from the extracted data.

In the present invention, a storage medium may store a program which enables a computer to execute a method comprising the steps of:

receiving location information;

instructing the computer to store data; and

storing and correlating, when the instruction is made at the instructing step, the data and the location information received at the receiving step.

In the present invention, a storage medium may store a program which enables a computer to execute a method comprising the steps of:

prompting the user of the portable information terminal to select particular location information from among pre-stored location information;

prompting the user to select particular data from among pre-stored data; and

correlating and storing data and location information selected by the user.

A program according to the present invention may enable a computer to execute a method comprising the steps of:

correlating and storing location information and data;

receiving location information;

extracting data which correlates with the received location information from the data stored at the storing step; and

notifying a user of the portable information terminal of information derived from the extracted data.

A program according to the present invention may enable a computer to execute a method comprising the steps of:

receiving location information;

instructing the computer to store data; and

storing and correlating, when the instruction is made at the instructing step, the data and the location information received at the receiving step.

A program according to the present invention may enable a computer to execute a method comprising the steps of:

prompting the user of the portable information terminal to select particular location information from among pre-stored location information;

prompting the user to select particular data from among pre-stored data; and

correlating and storing data and location information selected by the user.

### BRIEF DESCRIPTION OF THE DRAWINGS

FIG. 1 is a block diagram of a mobile telephone according to one embodiment of the present invention.

FIG. 2 shows a file configuration of data file 18.

FIG. 3 is a flowchart showing an operation of the mobile telephone according to the present invention for using location information.

FIG. 4 is a flowchart showing an operation of the mobile telephone according to the present invention for registering a user input data.

FIG. 5 shows events which occur in base station areas and which are initiated by the mobile telephone of the embodiment.

### EMBODIMENT

With reference to the drawings, a preferred embodiment of the present invention will now be described. The following embodiment is one example of the present invention and is not restrictive, and it will be obvious to those skilled in the art that a variety of modifications are possible without departing from the spirit and scope of the invention.

[1] Configuration

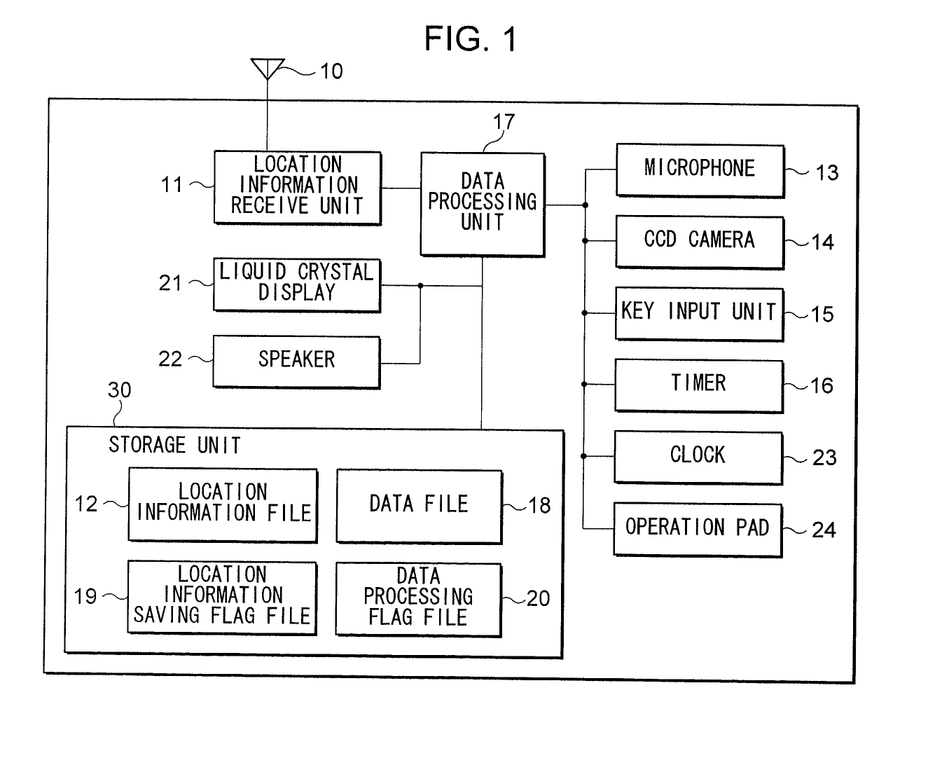

With reference to FIG. 1, explanation of a mobile telephone 1 according to one embodiment of the present invention will be described first.

Among the elements, data processing unit 17 has a central processing unit (CPU) and controls mobile telephone 1.

In this embodiment, a base station code BSC of the base station with which the mobile telephone communicates is used as location information. Location information receive unit 11 receives a base station code BSC sent from the mobile communication network via antenna 10. Data processing unit 17 stores the received base station code BSC in location information file 12.

Microphone 13 collects sound and outputs it as voice data. CCD camera 14 captures an image and outputs it as image data. Key input unit 15 outputs character data (including numbers and signs) corresponding to pressed keys. At a set time, timer 16 outputs a notice signal Sa. Clock 23 keeps time and date, and outputs current time information Sb which indicates a current time and date. Numeral 21 indicates a liquid crystal display. Numeral 22 indicates a speaker.

Numeral 24 indicates an operation pad, and the user of the mobile telephone can use it to record, take a picture, or save a text. Operation pad 24 outputs signals according to the user's operation and provides it to data processing unit 17.

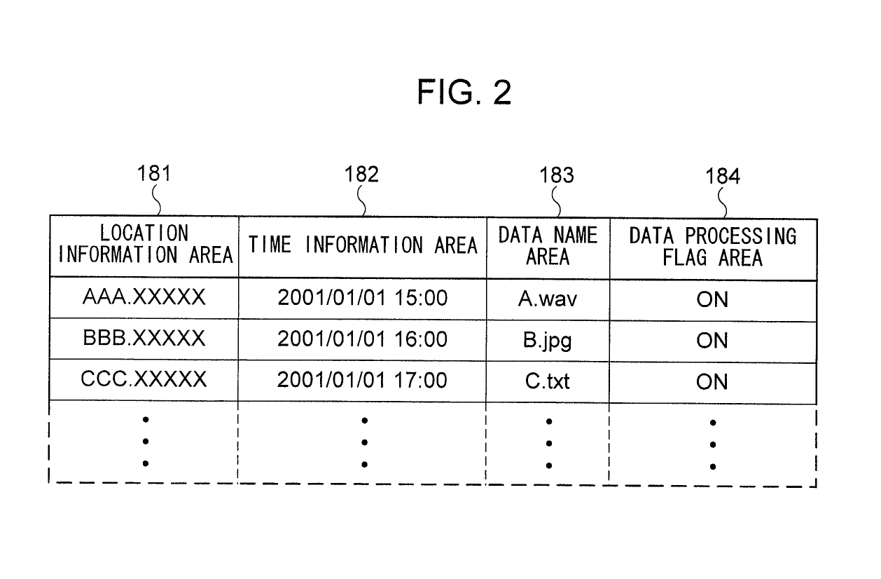

Storage unit 30 contains location information file 12, data file 18, location information flag file 19, and data processing flag file 20. As shown in FIG. 2, data file 18 has plural records each of which includes location information, time information, data name, data processing flag, and user input data.

By operating the operation pad 24, a user enables data processing unit 17 to store in data file 18 a voice data (data of sound within a range people can hear) that is output from microphone 13, an image data output from CCD camera 14, or a character data output from key input unit 15 (these are collectively called user input data hereinafter).

In the area of location information 181, the base station code BSC stored in location information file 12 at the time of generation of user input data is stored. Here, the time of generation is the time of recording using microphone 13 when user input data is voice data, the time of taking a picture using CCD camera 14 when user input data is image data, and the time of saving text data using key input unit 15 when user input data is character data.

In the area of time information 182, data indicating time and date output from clock 23 at the time of generation of user input data is stored.

In the area of data name 183, the data name for identifying user input data is stored. Data processing flag 184 is set to the same setting as data processing flag file 20 of the generation time of user input data.

Data processing flag file 20 has data of ON or OFF. Data processing flag in data file 18 is set at the same setting as the data of data processing flag file 20. Data processing flag in data file 18 indicates whether user input data stored in data file 18 is to be used or not. When the data processing flag in data file 18 is set at ON, the user input data is used in connection with the received location information. When the data processing flag in data file 18 is set at OFF, the user input data is not used in connection with the received location information. The user of mobile telephone 1 uses the operation pad 24 to change the data of data processing flag file 20 between ON and OFF.

Location information saving flag file 19 has data of ON or OFF. Location information flag in data file 18 is set at the same setting as the location information saving flag file 19. Location information flag in data file 18 indicates if the base station code BSC is saved in relation to a user input data when registering the user input data. When the location information saving flag is set at ON, the base station code BSC is saved in connection with user input data. When the location information saving flag is set at OFF, the base station code BSC is not saved. The user of mobile telephone 1 uses the operation pad 24 to change the data of location information saving flag file 19 between ON and OFF.

[2] Operation

[2.1] Obtaining Location Information

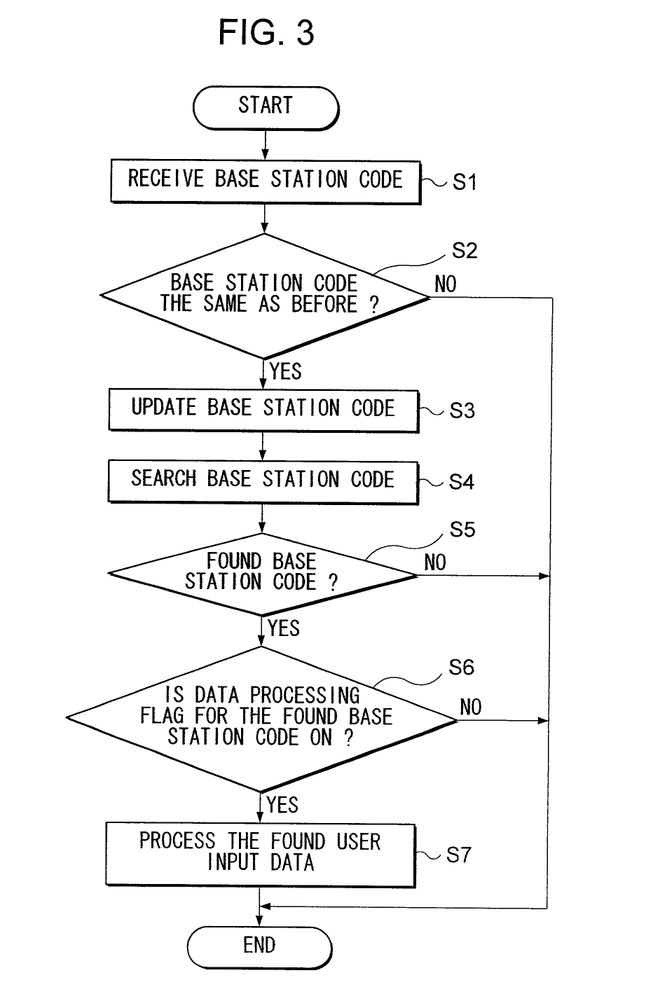

With reference to FIG. 3, the operation by which mobile telephone 1 of the embodiment obtains location information will be described. The flowchart shown in FIG. 3 illustrates an operation which is periodically conducted after switching mobile telephone 1 to ON. In other words, an interrupt occurs periodically to the CPU of mobile telephone 1, and this flowchart is processed.

First, data processing unit 17 causes location information receive unit 11 to receive from the mobile communication network base station code BSC of the base station with which mobile telephone 1 is communicating (step S1).

Data processing unit 17 compares this base station code BSC with that in location information file 12 and determines if there is a change in base station code BSC (step S2).

When it is determined at step S2 that the two base station codes BSC are the same (step S2: NO), the processing of this flowchart is completed.

On the other hand, when it is determined at step S2 that base station code BSC is not the same as the previous one (step S2: YES), data processing unit 17 updates base station code BSC stored in location information file 12 into the one received by location information receive unit 11 (step S3). Step S4 and the following steps are the steps for using location information and are explained later.

By this processing, location information file 12 always stores base station code BSC of the base station with which mobile telephone 1 is communicating.

Also, when data processing unit 17 receives a notice signal Sa from timer 16, data processing unit 17 stores in data file 18 current time information Sb output from clock 23 and base station code BSC stored in location information file 12 at the time of receiving the notice signal Sa. The current time information Sb and base station code BSC are correlated during this storing operation.

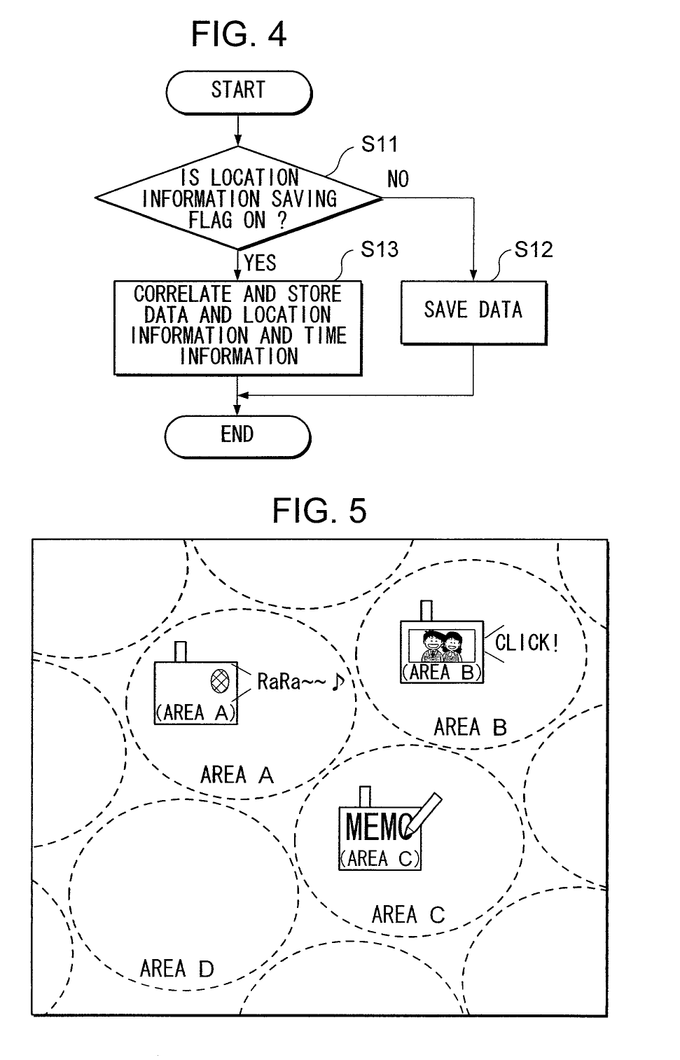

By this procedure, the base station code stored in location information file 12 and current time information Sb are automatically stored. Hence, by setting a timer in advance, the latest base station code BSC at the time of setting of the timer is stored automatically.

[2.2] An Actual Example of Registering User Input Data With reference to FIGS. 4 and 5, the process of correlating user input data with location information and registering them into mobile telephone 1 according to the embodiment will be described.

First, an explanation is given of a case where a user with mobile telephone 1 of the embodiment moves to an area A made by a certain base station on Jan. 1st, 2001.

In this case, as described, in accordance with the flowchart of FIG. 3, location information receive unit 11 receives base station code BSC of the base station in area A, and data processing unit 17 saves it into location information file 12.

Then, for example, when the user of mobile telephone 1 uses operation pad 24 to record sound at 3 PM, the signal by this recording operation is provided to data processing unit 17. By this recording operation, an interrupt occurs to the CPU, and the flowchart shown in FIG. 4 is carried out. Following this flowchart, data processing unit 17 stores voice data input from microphone 13 as follows.

First, data processing unit 17 determines if the location information saving flag file 19 has data of ON or not (step S11). When it is determined that the location information saving flag file 19 has OFF data (step S11: NO), the data processing unit 17 stores the voice data input from microphone 13 into data file 18 (step S12). On the other hand, when it is determined that the location information saving flag file 19 has ON data (step S11: YES), the data processing unit 17 correlates base station code BSC of the base station in area A stored in location information file 12 and current time information Sb indicating 3 PM on Jan. 1st, 2001 with the voice data input from microphone 12, and stores them into data file 18 (step S13).

By this procedure, the user of mobile telephone 1 can know the voice data is the one recorded at 3 PM Jan. 1st, 2001 at area A.

Next, an explanation is given of a case where the user of the mobile telephone 1 moves from area A to area B. In this explanation, since the processes are the same as those of area A, the names of the steps in the flowchart is not written down. First, base station code BSC of the base station in area B is stored in location information file 12 as described above.

Then, when the user of mobile telephone 1 uses operation pad 24 to take a picture at 4 PM, the signal generated by this picture taking operation is provided to data processing unit 17. Data processing unit 17 stores image data input from CCD camera 14 into data file 18. When storing, if the location information saving flag file 19 has ON data, the data processing unit 17 relates base station code BSC of the base station in area B stored in location information file 12 and the current time information Sb indicating 4 PM on Jan. 1st, 2001 with the image data input from CCD camera 14, and stores them into data file 18.

By this procedure, the user of mobile telephone 1 can know the image data is the one taken at 4 PM Jan. 1st, 2001 at area B.

Then when the user with mobile telephone 1 moves from area B to area C, base station code BSC of the base station in area C is stored in location information file 12 as described above with reference to FIG. 3.

Then when an operation for saving a text is conducted by using operation pad 24, the signal by this saving operation is provided to data processing unit 17. Data processing unit 17 stores text data input from key input unit 15 in the same manner as those in areas A and B.

[2.3] Operation When Using User Input Data

With reference to FIGS. 3 and 5, an explanation is given of a case where mobile telephone 1 of the embodiment processes the stored user input data referring to location information.

First, an explanation is given of a case where a user having mobile telephone 1 of the embodiment moves to one base station area A.

In this case, as described above, location information receive unit 11 receives base station code BSC of the base station in area A (step S1). Data processing unit 17 compares the received base station code BSC with the one stored in location information file 12 (step S2). When the two are the same (step S2: NO), the process of this flowchart is completed. When there is a change (step S2: YES), the data processing unit 17 updates the base station code in location information file 12 with the one received by location information receive unit 11 (step S3).

Then, the data processing unit 17 searches in the area of location information 181 in data file 18 if there is a base station code BSC the same as the received one (step S4). When the same base station code BSC as the received one is found (step S5: YES), data processing unit 17 examines data processing flag in the record for the base station code BSC (step S6). When the data processing flag is set at ON (step S6: NO), data processing unit 17 ends the process of this flowchart. When the data processing flag is set at OFF (step S6: YES), data processing unit 17 deals with the user input data in the record for the base station (step S7).

To illustrate this further, when the user moves into area A, a voice data stored as in the explanation [2.2] is extracted, and data processing unit 17 plays this voice data and outputs to speaker 22.

Similarly, when the user of mobile telephone 1 moves to area B, an image data stored as in the explanation [2.2] is extracted, and data processing unit 17 displays it on liquid crystal display 21.

Also, when the user of mobile telephone 1 moves to area C, a text data stored as in the explanation [2.2] is extracted, and data processing unit 17 displays it on liquid crystal display 21.

When there exists different data having relation to the same base station code BSC, data processing unit 17 deals with only the latest data. However, dealing with all extracted data is possible.

[3] Modifications of Embodiment

In the above explanation, mobile telephone 1 is used as a portable information terminal. However, a portable information terminal is not limited to mobile telephones, and can be an information terminal connected to a mobile telephone.

In the above embodiment, based on location information saving flag file 19, a decision is made whether or not to correlate a user input data and a base station code. However, there are other methods to decide whether to correlate them or not. For example, it is possible to always correlate a user input data and a base station code and store them. By this procedure, location information saving flag file 19 becomes unnecessary; making the configuration of mobile telephone 1 simpler.

Also, in the above embodiment, the setting of data processing flag 184 in data file 18 is set to the same as the data of data processing flag file 20. However, there are other methods to determine the setting of data processing flag 184 in data file 18. For example, it is possible to enable a user to select, when saving a user input data, if the user input data should be utilized at a later date; and to set the flag accordingly.

Also, there is another method such as, when saving a user input data, letting the user select a place where he or she wants the user input data to be dealt with. In this case, when saving user input data, mobile telephone 1 obtains all the base station codes of the base stations from the database of the mobile communication system. Then data processing unit 17 lets the user select a base station where he or she wants the user input data to be dealt with. Then data processing unit 17 correlates the selected base station code with the user input data, sets the data processing flag in the record of that user input data, and saves them in data file 18.

It is also possible to change the base station code related to the stored user input data. In this case, mobile telephone 1 has to obtain all base station codes from the database of the mobile communication network in advance to let the user select a base station code. Also, mobile telephone 1 has to have a means to let the user select a base station from among all the base station codes, and a means to let the user select a user input data among the user input data stored in data file 18. Data processing unit 17 then correlates the selected user input data with the selected base station code and stores them into data file 18. By this procedure, even at a place where the user comes for the first time, the user input data which correlates with the place can be displayed or accessed.

In the above embodiment, the user uses keys in key input unit 15 to input character data. However, the method of inputting character data is not limited to the use of keys. For example, using a graphics tablet is also possible. In this case, character data is input based on the pen's path on the tablet. By using a graphics tablet as an input device, it is easy to draw a picture and takes notes to store; enhancing the function for memory.

In the above embodiment, base station codes are used as location information. However, location information is not limited to base station codes. For example, information obtained from a GPS receiver can be used. To do this, the mobile telephone is equipped with a GPS receiver, and interprets the signals received by the GPS receiver to get location information. Also, information other than the base station codes can be used when that information can specify the current location of the mobile telephone.

In the above embodiment, base station codes are used as location information. However, information indicating a concrete place can be used as location information instead of base station code. For example, in the case where a mobile telephone is equipped with wireless LAN function to exchange information with a wireless access point, the place of the wireless access point such as a home or an office may be correlated with the data. To do this, an identification number of a wireless access point at home is pre-registered into the mobile telephone. And when the mobile telephone detects the identification number of the wireless access point of home, the information indicating “home” is used instead of a base station code. Similarly, when the mobile telephone detects the identification number of the wireless access point at the place of work or the office, the information indicating “office” is used instead of a base station code. By this procedure, the user of the mobile telephone can know his or her current location more easily.

In the above embodiment, location information file 12 stores the received base station codes, and the base station codes are correlated with user input data and stored in data file 18. However, the method of storing base station code is not limited to this method. For example, without using location information file 12, the base station code that is being received by location information receive unit 11 can be stored in data file 18. In this case, when there is user input data to store, storing this user input data is suspended until location information receive unit 11 receives the next base station code. When location information receive unit 11 receives the next base station code, the user input data is stored after correlating with the received base station code. By this procedure, location information file 12 becomes redundant; enabling a simpler configuration, and making memory usage more effective.

To realize the above functions in a mobile telephone, there are methods other than installing the program for these functions in advance in the mobile telephone. For example, reading the program from a storage media and installing it into the mobile telephone may be possible. Also, downloading the program via a telecommunication network and installing it into the mobile telephone can also be envisaged.

What is claimed is:

1. A portable information terminal comprising:
a storage unit for correlating and storing location information and data;
a receive unit for receiving location information;
an extract unit for extracting data on the received location information from data stored in the storage unit; and
an information notification unit for notifying a user of the portable information terminal of information derived from the extracted data.

2. A portable information terminal of claim 1, further comprising:
an operation unit for instructing to data storage; and
wherein the storage unit, when the instruction is made by the operation unit, correlates and stores data and location information received by the receive unit.

3. A portable information terminal of claim 1, further comprising:
a location information select prompting unit for prompting a user to select a location information from among different pre-stored location information; and
a data select prompting unit for prompting the user to select a data from among various pre-stored data; and
wherein the storage unit correlates and stores data and location information selected by the user.

4. A portable information terminal comprising:
a receive unit for receiving location information;
an operation unit for instructing to store data; and
a storage unit for, when the instruction is made by the operation unit, correlating and storing the data and the location information received by the receive unit.

5. A portable information terminal comprising:
a location information select prompting unit for prompting the user of the portable information terminal to select a location information from among pre-stored location information;
a data select prompting unit for prompting the user to select a data from among pre-stored data; and
a storage unit for correlating and storing data and location information selected by the user.

6. A portable information terminal of claim 1:
wherein the information notification unit is a liquid crystal display for displaying an image corresponding the data, or is a speaker for outputting sound corresponding to the data.

7. A portable information terminal of claim 1:
wherein the location information is a base station code of the base station with which the portable information terminal is communicating.

8. A portable information terminal of claim 4:
wherein the location information is a base station code of the base station with which the portable information terminal is communicating.

9. A portable information terminal of claim 5:
wherein the location information is a base station code of the base station with which the portable information terminal is communicating.

10. A portable information terminal of claim 1:
wherein
the portable information terminal has a GPS receiver; and
the location information is information obtained based on the signal received by the GPS receiver.

11. A portable information terminal of claim 4:
wherein
the portable information terminal has a GPS receiver; and
the location information is information obtained based on the signal received by the GPS receiver.

12. A portable information terminal of claim 5:
wherein
the portable information terminal has a GPS receiver; and
the location information is information obtained based on the signal received by the GPS receiver.

13. A method of controlling a portable information terminal, the method comprising the steps of:
correlating and storing location information and data;
receiving location information;
extracting data which correlates with the received location information from the data stored at the storing step; and
notifying a user of the portable information terminal of information derived from the extracted data.

14. A method of controlling a portable information terminal, the method comprising the steps of:
receiving location information;
instructing the portable information terminal to store data; and
storing and correlating, when the instruction is made at the instructing step, the data and the location information received at the receiving step.

15. A method of controlling a portable information terminal, the method comprising the steps of:
prompting the user of the portable information terminal to select a location information from among pre-stored location information;
prompting the user to select a data from among various pre-stored data; and
correlating and storing data and location information selected by the user.

16. A storage medium storing a program for enabling a computer to execute a method comprising the following steps of:
correlating and storing location information and data;
receiving location information;
extracting data which correlates with the received location information from data which is stored at the storing step; and
notifying a user of the portable information terminal of information derived from the extracted data.

17. A storage medium storing a program for enabling a computer to execute a method comprising the steps of:
receiving location information;
instructing the computer to store data; and
storing and correlating, when the instruction is made at the instructing step, the data and the location information received at the receiving step.

18. A storage medium storing a program for enabling a computer to execute a method comprising the steps of:
prompting the user of the portable information terminal to select a location information from among pre-stored location information;
prompting the user to select a data from among pre-stored data; and
correlating and storing the data and location information selected by the user.

19. A program to enable a computer to execute a method comprising the steps of:
correlating and storing location information and data;
receiving location information;
extracting data which correlates with the received location information from the data stored at the storing step; and
notifying a user of the portable information terminal of information derived from the extracted data.

20. A program to enable a computer to execute a method comprising the steps of:
receiving location information;
instructing the computer to store data; and
storing and correlating, when the instruction is made at the instructing step, the data and the location information received at the receiving step.

21. A program to enable a computer to execute a method comprising the steps of:
prompting the user of the portable information terminal to select a location information from among pre-stored location information;
prompting the user to select a data from among pre-stored data; and
correlating and storing data and location information selected by the user.
